(19) United States
(12) Patent Application Publication
(10) Pub. No.: US 2019/0102287 A1
(43) Pub. Date: Apr. 4, 2019

(54) REMOTE PERSISTENT MEMORY ACCESS DEVICE

(71) Applicant: Intel Corporation, Santa Clara, CA (US)

(72) Inventors: Phil C. Cayton, Warren, OR (US); Dave B. Minturn, Hillsboro, OR (US); James P. Freyensee, Hillsboro, OR (US); Jay E. Sternberg, North Plains, OR (US)

(21) Appl. No.: 15/720,885

(22) Filed: Sep. 29, 2017

(51) Int. Cl. G06F 12/02; G06F 3/06; H04L 29/06; H04L 29/10; H04L 12/40; H04L 12/413

(52) U.S. Cl. CPC G06F 12/0238; G06F 3/0619; G06F 3/0638; G06F 3/0604; G06F 2212/202; H04L 29/06; H04L 29/10; H04L 12/40013; H04L 12/413; G06F 3/061

(57) ABSTRACT

Systems, apparatuses and methods may provide for technology that detects received data at a network interface controller. The network interface controller may be connected with a local memory including a persistent non-volatile memory directly accessible only by the network interface controller. The technology may determine whether to store the received data in the local memory or a system memory including a persistent non-volatile memory region. The technology may store the received data in the local memory or the system memory according to the determining.

### TECHNICAL FIELD

Embodiments generally relate to network interface controllers.

### BACKGROUND

Storage systems may use non-volatile memory (NVM) media such as NAND or three-dimensional (3D) cross-point (e.g., 3D XPoint™) technology for solid state drives (SSDs) to store data in volumes. Storage systems that are compliant with NVMe (NVM Express) may connect directly to a PCIe (Peripheral Components Interconnect Express) bus via a unified software stack having a streamlined register interface and command set designed for NVM-based storage transactions over PCIe.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of a network storage architecture according an embodiment of the disclosure;

FIGS. 2A-2B are flowcharts of examples of methods of reading data according to embodiments of the disclosure;

FIGS. 3A-3B are flowcharts of examples of methods of writing data according to embodiments of the disclosure;

FIG. 4 is an illustration of an example of a network storage architecture and flows during a write operation according to an embodiment of the disclosure;

FIGS. 5 and 6 are illustrations of examples of network storage architectures and flows during read operations according to embodiments of the disclosure;

FIG. 7 is an illustration of an example of a network storage architecture and flows during a write operation according to an embodiment of the disclosure;

FIG. 8 is an illustration of an example of a network storage architecture and flows during a loop back operation according to an embodiment of the disclosure;

FIG. 9 is a flowchart of an example of a method of managing memory according to an embodiment of the disclosure;

FIG. 10 illustrates an example of an RDMA device according to an embodiment of the disclosure;

FIG. 11 illustrates an example of a computing architecture according to an embodiment of the disclosure;

FIG. 12 illustrates an example of a processor core according to an embodiment of the disclosure;

FIG. 13 illustrates a block diagram of a performance-enhanced computing system according to an embodiment of the disclosure;

FIG. 14 is a block diagram of an example of a system according to an embodiment of the disclosure; and

FIG. 15 is a block diagram of an example of a computing system according to an embodiment of the disclosure.

### DESCRIPTION OF EMBODIMENTS

Network Interface Controllers (NICs) may support remote direct memory access (RDMA) from one computing node into another computing node. Such an access may minimally involve an operating system (OS) of either node, and may also be independent of or minimally involve a processor (e.g., central processing unit/CPU) of at least one of the nodes. RDMA may allow for high-throughput and low-latency operations. For example, it may be beneficial to use RDMA technology when big data is being processed by several nodes. A NIC that supports RDMA may be referred to as a RDMA NIC (RNIC).

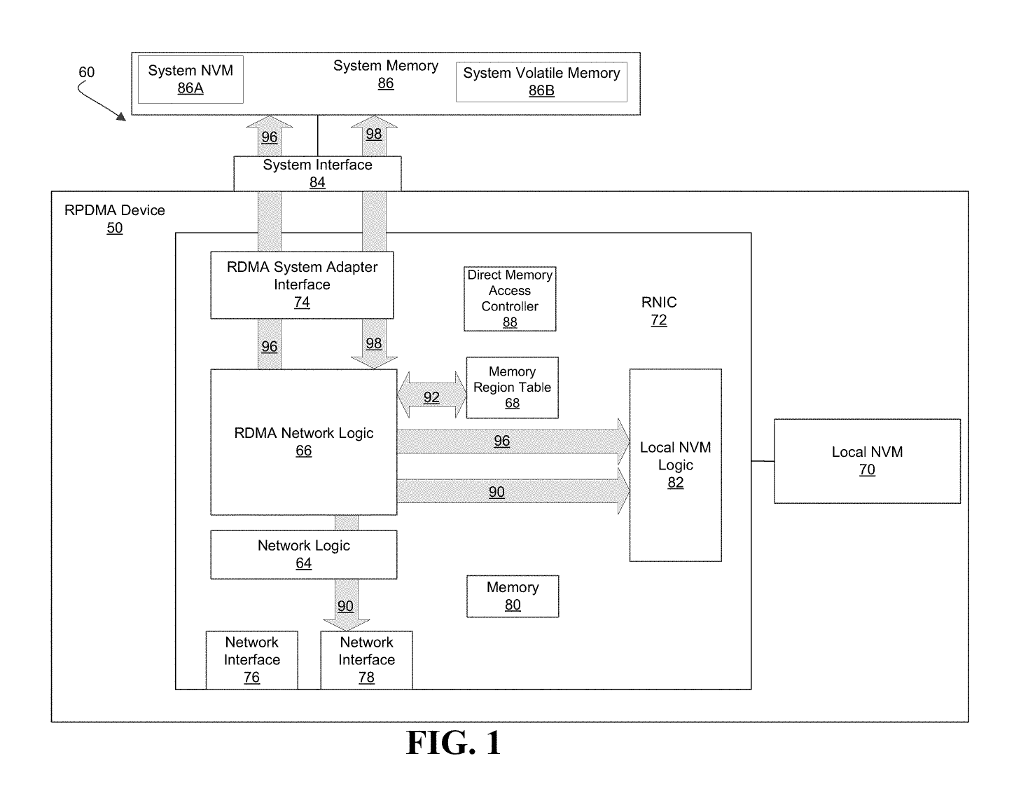

In some embodiments as illustrated in FIG. 1, an RNIC 72 may be co-resident with an NVM, such as local NVM 70, and may be utilized for low-latency application models where remote memory accesses are not to interfere with access to local memories (e.g., NVM replication, pooled NVM, ephemeral distributed memory). For example, certain applications may produce data locally, and require the data to be accessed remotely (e.g., big-data analytics). In such a situation, it may be preferable to store data proximate to the RNIC 72 on the local NVM 70 to facilitate low-latency data transfers over a network. For example, if data is to be frequently transferred over the network, it may be preferable to store the data locally to the RNIC 72. Thus, the RNIC 72 may be able to directly access (e.g., write to and read from) the local NVM 70. Such a device may be referred to as a remote persistent memory access (RPDMA) device 50.

The RPDMA device 50 may reduce the latency and number of data transfers compared to a system in which an RNIC must access a system NVM (e.g., shared NVM of a computing device such as a dual in-line memory module including NVM and/or an NVM on a separate PCIe device) to store data. In such a case, the RNIC cannot directly access the NVM without going through the RNIC's PCIe input/output (I/O) connection such as a RDMA system adapter interface. In contrast, the RPDMA device 50 may process data reads/writes in the RPDMA device 50 without involving a RDMA system adapter interface 74, a system interface 84, memory of a storage target such as, for example, system memory 86, etc., and without conducting further reads to ensure that the data is persistent, allowing an enhanced, low-latency operation to read and write data.

More particularly, FIG. 1 illustrates a network storage architecture 60 including the RPDMA device 50 and the system memory 86. The system memory 86 and its media technology may be DRAM, NAND, 3D XPoint™ technology, dual in-line memory module (DIMM) including a non-volatile memory, and so on. The system memory 86 may include system NVM 86A (such as 3D XPoint™ memory) and remote volatile memory 86b. The system NVM 86A and remote volatile memory 86b may be referred to as volatile and non-volatile memory regions. The system memory 86 may be separate from the RPDMA device 50. To read/write to the system memory 86, the RPDMA device 50 may need to utilize system interface 84. The system interface 84 may be a PCIe interface which may transmit and receive data over a PCIe bus, or a double-data-rate interface. In order to write to the system memory 86, data may be transferred from the RPDMA device 50 to the system memory 86, then a PCIe read operation ensures that the data is made persistent. The system memory 86 and RPDMA device 50 may be on a same computing device, such as a server. In some embodiments, the system memory 86 and RPDMA device 50 may in separated computing devices, such as different servers. For example, an operating system may be present the system memory 86 and local NVM 70 to the local machine as local but virtual resources. Behind that virtual implementation the system memory 86 and local NVM 70 may be on different systems.

In contrast, local NVM 70 of the RPDMA device 50 may be directly accessible to RNIC 72, without accessing the system interface 84, system interconnects, system bus or system memory 86. Rather, the RNIC 72 may be connected to the local NVM 70 via local interconnects such as local PCIe connections or local interconnect DDR connections. Thus, some remote accesses may be completely contained within the RPDMA device 50. Furthermore, the local NVM 70 may not be directly written into or read out from by other devices, except for the RNIC 72, so that only the RNIC 72 may directly read/write to the local NVM 70. For example, the local NVM logic 82 may write into and read from the local NVM 70. If another device, node or machine is to store data via the RPDMA device 50, the RPDMA device 50 determines which memory 70, 80, 86A, 86B to store the data within, and then stores the data. Therefore, the RPDMA device 50 may provide a consistent interface between local and remote memory storage operations. The RPDMA device 50 may include one form factor comprising both the RNIC 72 and the local NVM 70.

Since the RNIC 72 is the only device that directly accesses (e.g., directly writes into and directly reads out from) the local NVM 70, some enhancements with respect to access methods may be achieved, such as data striping or partial cache line. Furthermore, in some examples, the local NVM 70 may be byte-addressable and under complete control of the RNIC 72, which may enhance data transfers and data indexing via RDMA Verb interfaces, thereby enhancing data network bandwidth in a network-storage data center for example. In some embodiments, the local NVM 70 may be NAND technology. In some embodiments the local NVM 70 may be word addressable.

As noted above, extra reads to verify persistence may be avoided by implementing the RNIC 72 to have direct access to the local NVM 70, as opposed to storing information on the system memory 86. For example, the local NVM logic 82 may detect and then indicate that the data is written in a persistent state. Power fail may be handled by sufficient capacitance, and writes to the local NVM 70 may not be marked as complete by the local NVM logic 82 until the associated data is put into a power-fail protected state such as on local NVM 70. Moreover, the local NVM 70 and the system memory 86 may store different data. As such, there is no requirement that the system memory 86 and the local NVM 70 are synchronized.

The local NVM 70 may be 3D XPoint™ memory, or another type of NVM. For example, the local NVM 70 may be an NVM implementing a bit addressable storage by a change of bulk resistance, in conjunction with a stackable cross-gridded data access array. 3D XPoint memory is a transistor-less, crosspoint technology, and is a 3-dimensional stackable media technology, allowing memory layers to be stacked on top of each other in a 3D manner.

Non-volatile memory is a storage medium that does not require power to maintain the state of data stored by the medium. A memory device may also include future generation non-volatile devices, such as a 3D XPoint™ memory device, as already noted, or other byte addressable write-in-place nonvolatile memory devices. In one embodiment, the memory device may be or may include memory devices that use silicon-oxide-nitride-oxide-silicon (SONOS) memory, electrically erasable programmable read-only memory (EEPROM), chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thiristor based memory device, or a combination of any of the above, or other memory. The memory device may refer to the die itself and/or to a packaged memory product. In some embodiments, 3D XPoint™ memory may comprise a transistor-less stackable cross point architecture in which memory cells sit at the intersection of words lines and bit lines and are individually addressable and in which bit storage is based on a change in bulk resistance. In particular embodiments, a memory module with non-volatile memory may comply with one or more standards promulgated by the Joint Electron Device Engineering Council (JEDEC), such as JESD218, JESD219, JESD220-1, JESD223B, JESD223-1, or other suitable standard (the JEDEC standards cited herein are available at jedec.org).

The RNIC 72 may include a direct memory access controller 88 to control some read/write operations, and a memory 80 which may be a volatile memory. The local NVM 70 and the memory 80 may be referred to as local memory. Network interfaces 76, 78 may be connected to a network (not shown), and receive data from the network and transmit data to the network. For example, a remote node may transmit data to the network interfaces 76, 78 to be stored in the local NVM 70. While two network interfaces 76, 78 are illustrated, more or less network interfaces may be provided. Furthermore, 3D XPoint™ memory may operate as both DRAM by being of a dual in-line memory module including the system memory 86, and permanent storage as the local NVM 70.

FIG. 1 further illustrates a flow 90 that transfers data between the network interface 78 and the local NVM 70. Furthermore, the flow 96 may transfer data between the local NVM 70 and the system memory 86.

A flow 92 illustrates the RDMA network logic 66 referencing a memory region table 68. While not illustrated, a translation table may also be included. The memory region table 68 may store virtual addresses of data, security permissions and physical or persistent addresses of the local NVM 70, memory 80 and system memory 86 associated with the virtual addresses.

Additionally, a flow 98 illustrates a loopback operation. During a loopback operation, data is read from the system memory 86 at a first location and first address, and written back to the system memory 86 at a second location and second address.

The memory region table 68 may include an index associated with the physical addresses. The memory region table 68 may include a plurality of indexed entries, where each entry in the memory region table 68 includes an index number, locality bit(s), persistence bit(s) and a physical page or address. The index may correspond to a portion (e.g., a key) of the virtual address. That is, the key may correspond to one of the index numbers. The key may be compared to the index to determine the physical address of data. That is, the virtual address may include the key and an offset, where the key may equal one of the index numbers, and the associated information in the memory region table 68 may indicate features (e.g., a physical address) of the local NVM 70, the memory 80, the system NVM 86A, or system volatile memory 86B into which the data is to be written into, or which stores the data associated with the virtual address. The offset may be appended to the physical address to determine the physical location of the data. Therefore, the memory region table 68 may include entries each including an index number, a virtual address, persistence bit(s) associated with that address, locality bit(s) associated with that address and a physical address.

The persistence bit(s) (which may also be referred to as a persistence field) may indicate whether the data associated with the virtual address is stored on the persistent non-volatile memory regions, for example system NVM 86A and the local NVM 70 (e.g., 3D XPoint™), or a volatile storage. For example, if the persistence bit is “1,” the RDMA network logic 66 may determine that the data is stored in the persistent memory regions 70, 86A, instead of a volatile memory, such as system volatile memory 86B and memory 80. Thus, the memory region table 68 may also have persistence bit(s) to indicate if the data is stored on local NVM 70, which may be a 3D XPoint™ media (which is a persistent technology), or DRAM (which is not a persistent technology) such as memory 80, since both a read and write to either 3D Xpoint™ media and DRAM may appear the same, unlike NAND-based NVM. The locality bit(s) (which may also be referred to as a locality field) indicates if the data associated with the virtual address is stored locally on the RPDMA device 50, for example on the local NVM 70 implemented with 3D XPoint™ technology, or remote, for example on another computer's memory that is accessible via RDMA by the RPDMA Device 50. With local NVM 70 acting as a memory module, RPDMA device 50 may not know if the address/data in question is local or remote to the RPDMA device 50, and thus a locality bit(s) may indicate the locality of the data. In another example, the locality bit(s) may indicate whether data is resident on system memory 86 or the RPDMA device 50. In this case, if the locality bit(s) is “1” (or a value representing this example) the data associated with the address may be stored locally on the RPDMA device 50, rather than on the system memory 86. The locality bit(s) may indicate whether the data is stored on one of several memories, which are not illustrated. In some embodiments, the locality bit(s) may include more than one bit to indicate not only whether the data is stored, but also a state of the data and how the data may be accessed. For example, when the locality bits value is “0,” a power-on state is present; when the locality bits have a value of “1,” data is stored off the RPDMA device 50 and in system memory 86; when locality bits value is “2,” data is stored off the RPDMA device 50 and on a remote system's memory accessible through RDMA device 50, for example with a similar system flow 90 which would go through network logic 64, RDMA network logic 66, network interface 78; and when the locality bits value is “3,” the data may be stored locally on the RPDMA device 50 on either local NVM 70 or memory 80.

A user may define the parameters of the memory region table 68, such as which virtual addresses are to be stored locally on local NVM 70, by setting association of addresses to the persistence bit(s) and the locality bit(s). The virtual addresses (and therefore the corresponding keys) may be shared with applications to be written into by those applications.

In some embodiments, if local NVM 70 is implemented as 3D XPoint™ memory, the RPDMA device 50 may periodically flush memory 80 to the local NVM 70 via local NVM logic 82 or other interconnects. Doing so may allow the RPDMA device 50 to consistently access data. As noted above, the locality and persistence bits may indicate whether the data is stored on the local NVM 70 or the memory 80.

In an example, the RPDMA device 50 may include a power-loss, data-loss policy in which data is periodically moved from the volatile memory to non-volatile memory. If the locality bit(s) and persistence bit(s) indicate that the data is stored in system volatile memory 86B, RPDMA device 50 may move the data from the system volatile memory 86B to the local NVM 70, and the memory region table 68 would then indicate that data is persistent (e.g., persistence bit(s) is 1) and local (e.g., locality bit(s) is 1). Also, the RPDMA device 50 may periodically move data from volatile memory 80 to local NVM 70; and the locality bit would still be set to local in this example, but the persistence bit(s) would switch from volatile (e.g., “0”) to non-volatile (e.g., “1”). This may allow for data to be backed up in a power-loss, data-loss strategy. The RPDMA device 50 may include an algorithm to execute the above, which may be implemented by a computer readable storage medium, logic, or any other suitable structure described herein.

As already noted, the local NVM 70 and system NVM 86A may include for example, phase change memory (PCM), three dimensional cross point memory, resistive memory, nanowire memory, ferro-electric transistor random access memory (FeTRAM), flash memory such as NAND or NOR, magnetoresistive random access memory (MRAM) memory that incorporates memristor technology, spin transfer torque (STT)-MRAM, and so forth. Moreover, a solid state drive (SSD) may have block based NVM such as NAND or NOR and may include byte-addressable write in place memory such as, for example, 3D XPoint™ memory and MRAM. These memory structures may be particularly useful in datacenter environments such as, for example, high performance computing (HPC) systems, big data systems and other architectures involving relatively high bandwidth data transfers. The local NVM 70 and system NVM 86A may include the same type of NVM or different types of NVM.

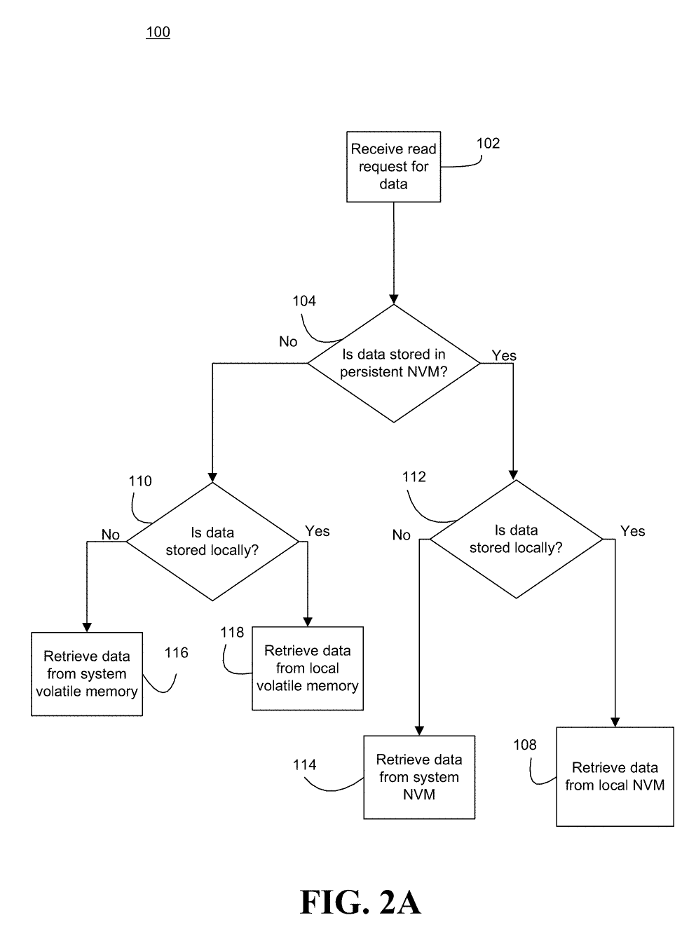

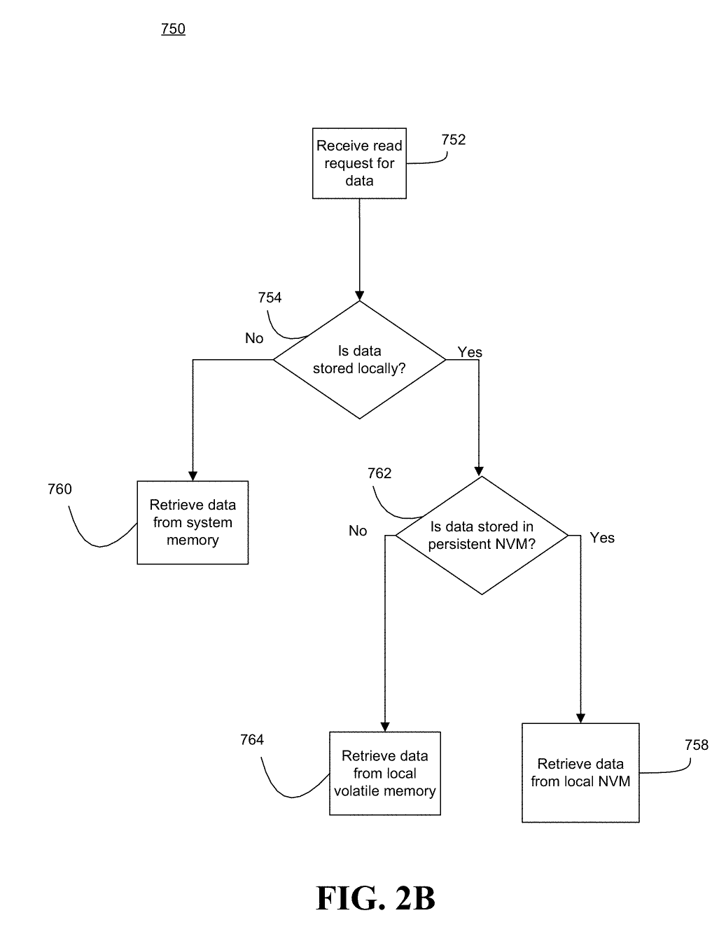

FIG. 2A shows a method 100 of reading data. The method 100 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor-logic (TTL) technology, or any combination thereof.

For example, computer program code to carry out operations shown in the method 100 may be written in any combination of one or more programming languages, including an object oriented programming language such as register transfer language) RTL, JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 102 receives a read request for data at a RPDMA device. The read request may be from a remote node, or from a local application. The RPDMA device may be part of a computing architecture including a system memory. Illustrated processing block 104 determines where the data is stored, and particularly whether the data is stored in volatile or non-volatile memory. For example, the RPDMA device may include a memory region table, which may be a lookup table. The location of the data may be determined by reference to the lookup table. As discussed above, the memory region table may include persistence bit(s) and locality bit(s).

If it is determined by illustrated processing block 104 that the data is not stored in persistent NVM, illustrated processing 110 determines if the data is locally stored. If not, illustrated processing block 116 may retrieve the data from system volatile memory. Otherwise, illustrated processing block 118 may retrieve the data from RPDMA volatile memory.

If at illustrated processing block 104, the data is determined to be stored in non-volatile memory, illustrated processing block 112 determines whether the data is stored locally on local NVM of the RPDMA device, in contrast to system NVM. As discussed above, the local NVM may be directly accessible only by the RPDMA device; in contrast the system NVM may be directly accessible by other devices. If so, illustrated processing block 108 retrieves the data from the local NVM, which may be a persistent non-volatile memory such as 3D XPoint™ memory. Otherwise, illustrated processing block 114 retrieves the data from system NVM.

FIG. 2B shows another method 750 of reading data. The method 750 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor-logic (TTL) technology, or any combination thereof.

For example, computer program code to carry out operations shown in the method 750 may be written in any combination of one or more programming languages, including an object oriented programming language such as register transfer language) RTL, JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 752 receives a read request for data at a RPDMA device. The read request may be from a remote node, or from a local application. The RPDMA device may be part of a computing architecture including a system memory. Illustrated processing block 754 determines whether the data is stored locally to the RPDMA device, in a local NVM, or remote to the RPDMA device for example in a system NVM or system volatile memory. For example, the RPDMA device may include a memory region table, which may be a lookup table. The location of the data may be determined by reference to the lookup table. As discussed above, the memory region table may include persistence bit(s) and locality bit(s).

If it is determined by illustrated processing block 754 that the data is not stored locally, illustrated processing 760 may communicate with another device (e.g., another RPDMA device) to retrieve the data from the system memory. As such, another RPDMA device may provide the data to the RPDMA device, which may be stored in volatile or non-volatile memory. Although not illustrated, the memory region table may include a persistence bit indicating whether the data is stored in volatile or non-volatile memory, and the another RPDMA device may retrieve the data accordingly.

If at illustrated processing block 754, the data is determined to be stored locally, illustrated processing block 762 determines whether the data is stored in the persistent local NVM. If the data is stored in the persistent local non-volatile memory, illustrated processing block 758 may retrieve the data from the persistent local NVM, which may be a persistent non-volatile memory such as 3D XPoint™ memory. As discussed above, the local NVM may be directly accessible only by the RPDMA device; in contrast the system memory, which may include a system NVM, may be directly accessible by other devices. Otherwise, illustrated processing block 764 retrieves the data from volatile memory, which may be part of the RPDMA device.

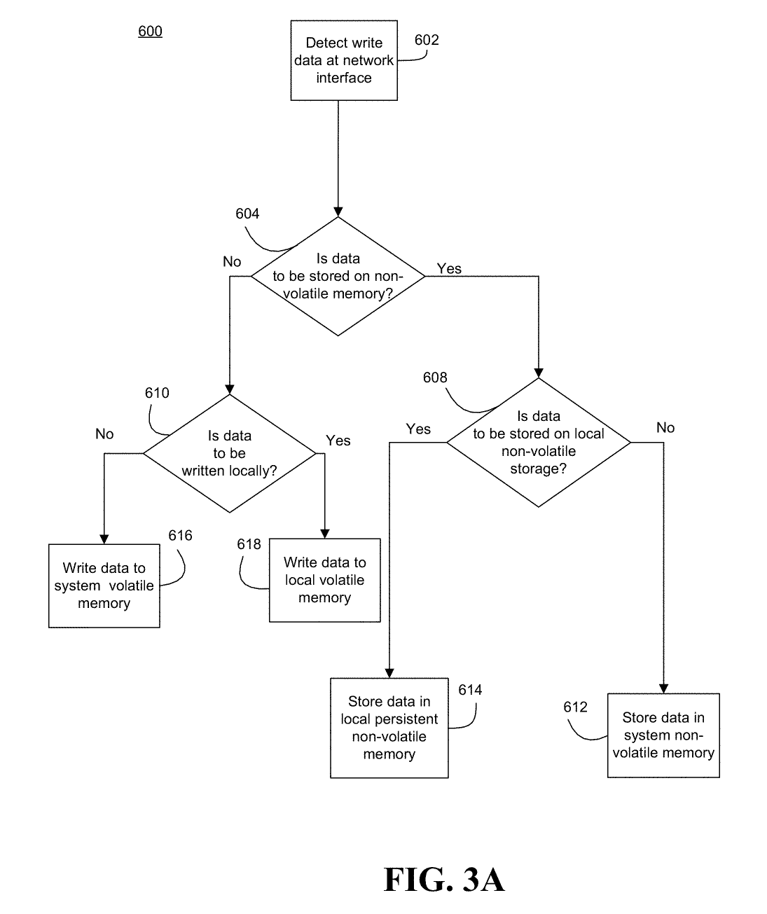

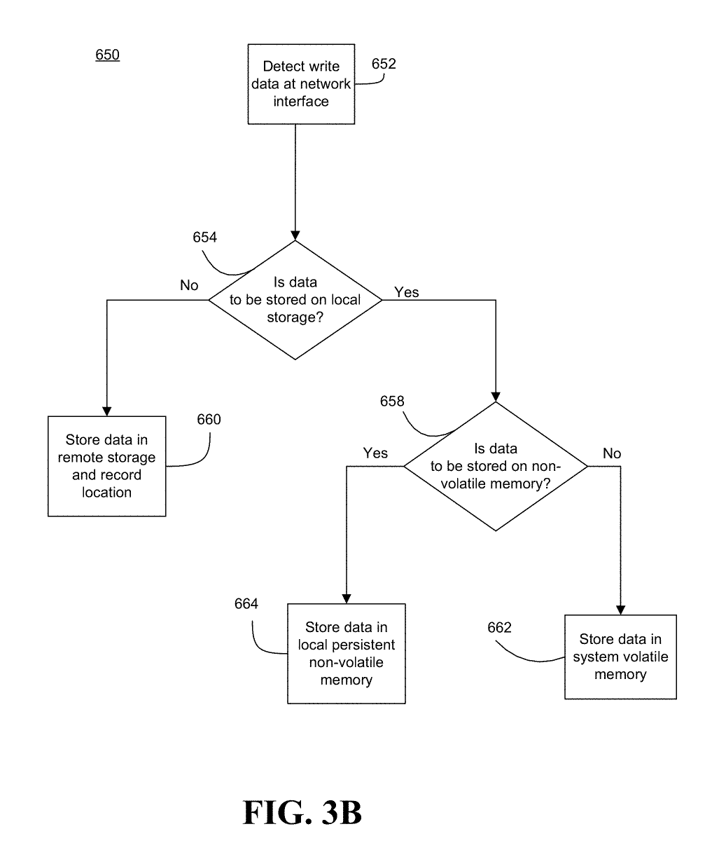

Although not illustrated, the above read operation may enhance situations like power-loss. For example, data stored in the local volatile memory could be periodically copied to the persistent non-volatile memory device. In some embodiments the memory table may be updated to reflect as much, and the above method 750 may be able to retrieve the copied data. Turning now to FIG. 3A, method 600 illustrates a method of writing data. The method 600 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

Illustrated processing block 602 detects, at an RPDMA device, an RDMA write request. Illustrated processing block 604 may determine whether the data is to be stored in non-volatile or volatile memory. Such a determination may occur with reference to a lookup table and may be indicated by a persistence bit(s). For example, a user may set preferences which allocate local NVM area of the RPDMA device to specific virtual address, and further associate volatile memory, RPDMA device local NVM or system non-volatile storage with other virtual addresses. Such allocations may be stored in a memory region table. The virtual address of the data may include an identifier, such as a key, which is indexed to the memory table and specific memory locations. These memory locations may have the persistence and locality bits set based upon the user allocations, and to indicate whether the virtual address is mapped to volatile memory, the NVM of the RPDMA device or the non-volatile device of the local NVM system. Therefore, RPDMA logic may resolve the key to the memory region table, to determine whether the data is to be stored in local volatile storage, the local NVM, system volatile memory or the (remote with respect to the RPDMA device) system NVM. For example, the RPDMA logic may determine an index number in the memory region table that is equal to the key, and determine a location to store the data based upon the physical address, the locality bit(s) and the persistence bit(s) associated with the index number. For example, a software application could assign a key value to data being managed by the RPDMA's memory region table. If the data is not to be stored on NVM, illustrated processing block 610 may determine whether the data is to be written locally from the locality bit(s). If so, illustrated processing block 618 may write the data into local RPDMA device volatile memory. Illustrated processing block 618 may also record the association in the memory region table. Otherwise, illustrated processing block 616 may write the data into system volatile memory. Illustrated processing block 616 may also record the association in the memory region table.

If the data is to be stored on non-volatile memory, illustrated processing block 608 may determine from the locality bit(s), whether the data is to be stored on the local non-volatile storage of the RPDMA device. If so, illustrated processing block 614 may store the data in the local persistent non-volatile storage and records the association in the memory region table. Otherwise, illustrated processing block 612 stores data in system NVM and records the association in the memory region table.

Turning now to FIG. 3B, method 600 illustrates a method of writing data. The method 600 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

Illustrated processing block 652 detects, at an RPDMA device, an RDMA write request. Illustrated processing block 654 may determine whether the data is to be stored in local storage. Such a determination may occur with reference to a lookup table and may be indicated by a locality bit(s). For example, a user may set preferences which allocate local NVM area of the RPDMA device to specific virtual address, and further associate volatile memory, RPDMA device local NVM or system memory (which may be NVM or volatile memory) with other virtual addresses. Such allocations may be stored in a memory region table. The virtual address of the data may include an identifier, such as a key, which is indexed to the memory table and specific memory locations. These memory locations may have the persistence and locality bits set based upon the user allocations, and to indicate whether the virtual address is mapped to volatile memory of the RPDMA device, the NVM of the RPDMA device or the system memory. Therefore, RPDMA logic may resolve the key to the memory region table, to determine whether the data is to be stored in the volatile storage, the local NVM, or the (remote) system memory. For example, the RPDMA logic may determine an index number in the memory region table that is equal to the key, and determine a location to store the data based upon the physical address, the locality bit(s) and the persistence bit(s) associated with the index number. For example, a software application could assign a key value to data being managed by the RPDMA's memory region table.

If the data is not to be stored on local storage, illustrated processing block 660 may store the data on the remote storage. For example, the RPDMA device may communicate with another device (e.g., another RPDMA device) to write the data from the system memory. Although not illustrated, the memory region table may include a persistence bit indicating whether the data is stored in volatile or non-volatile memory, and the another RPDMA device may write the data accordingly into a volatile or non-volatile memory. Illustrated processing block 660 may also record the association in the memory region table.

If the data is to be stored locally, illustrated processing block 658 may determine from the persistence bit, whether the data is to be stored on the local non-volatile storage of the RPDMA device. If so, illustrated processing block 664 may store the data in the local persistent non-volatile storage and records the location in the memory region table. Otherwise, illustrated processing block 662 stores data in volatile memory and records the location in the memory region table.

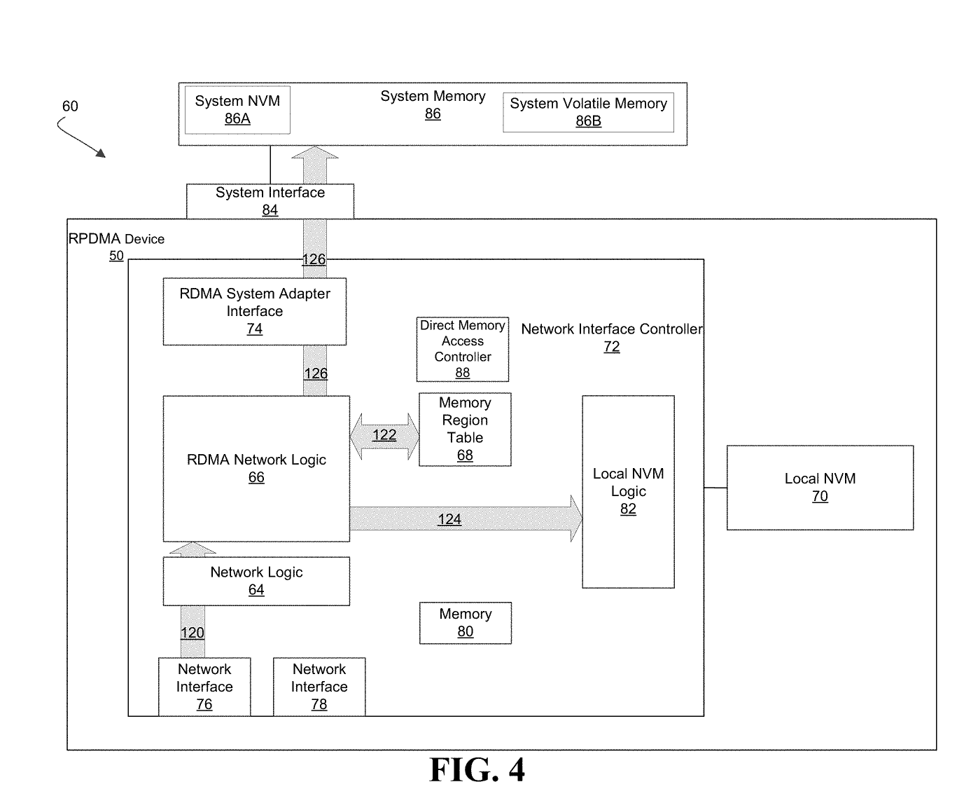

FIG. 4 illustrates the network storage architecture 60 during a write operation of data received from a network connected to the network interface 76, 78. The write operation may originate with a remote node or computing device, which is remote to the network storage architecture 60. A remote write request is received from the network as illustrated by flow 120, and detected by the network logic 64 and the RDMA network logic 66. The RDMA network logic 66 may access the memory region table 68 as illustrated by flow 122, to determine which memory region to write the data into. In some embodiments, the RDMA network logic 66 may detect a characteristic (e.g., a write address) associated with the data, and utilize this characteristic to lookup in the memory region table 68 whether to store the data in the local NVM 70 or the system NVM 86A. For example, a key value of the data may be indexed to the memory region table 68, and associated with locality and persistence bit(s) indicating whether the data should be stored in the local NVM 70, memory 80, the system volatile memory 86B or the system NVM 86A.

If the RDMA network logic 66 determines that the data should be stored in the local NVM 70, the network logic 66 may transmit the data to the local NVM logic 82, as illustrated by flow 124. The local NVM logic 82 stores the data in the local NVM 70. If the RDMA network logic 66 determines that the data is to be stored on the system NVM 86A, the data may be transmitted to the system NVM 86A, as illustrated by flow 126. For example, the data may be provided to the RDMA system adapter interface 74, to the system interface 84 and then to the system NVM 86A. Regardless of the storage location, after the operation to store the data is complete, an acknowledgement or a handshake may be transmitted to the remote node or computing device to indicate that the operation was successfully completed and the data has been made persistent.

In some embodiments, the RDMA network logic 66 may determine that the memory 80 or system volatile memory 86B should store the data. In such an embodiment, the RDMA network logic 66 may write the data into the memory 80 or system volatile memory 86B similarly to as described above.

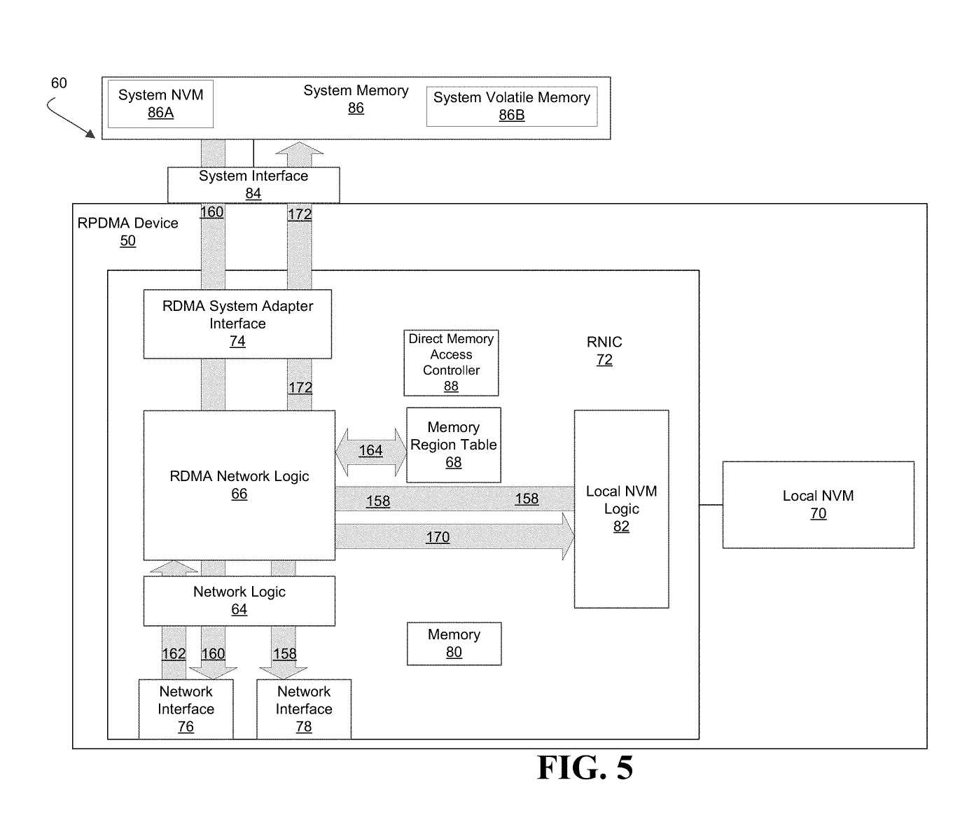

FIG. 5 illustrates the network storage architecture 60 during a read operation for a remote read request received from the network. The read operation may originate with a remote node or computing device, which is remote to the network storage architecture 60. The remote read request may include an address of data to be retrieved. A remote read request is received from the network as illustrated by flow 162, and detected by the network logic 64 and the RDMA network logic 66. The RDMA network logic 66 may access the memory region table 68 as illustrated by flow 164, to determine which memory region the data is stored within. In some embodiments, the RDMA network logic 66 may detect a characteristic (e.g., a read address) associated with or included with the request, and utilize this characteristic to lookup in the memory region table 68 whether the data is stored in the local NVM 70, memory 80, the system volatile memory 86B or the system NVM 86A. For example, a key value of the address associated with the data may be indexed to an entry of the memory region table 68, and the entry may include locality and persistence bit(s) indicating whether the data is saved in the local NVM 70, memory 80, system volatile memory 86B or the system NVM 86A.

If the RDMA network logic 66 determines that the data is stored in the local NVM 70, the RDMA network logic 66 may transmit the read request to the local NVM logic 82, as illustrated by flow 170. The local NVM logic 82 may retrieve the data from the local NVM 70, which is then provided to the remote node or computing device through the network and network interface 78, as illustrated by flow 158. For example, the data may be transmitted from the local NVM logic 82 to the RDMA network logic 66, in turn to the network logic 64, and finally to the network interface 78 to be provided to the network and then to the remote node or computing device.

If the RDMA network logic 66 determines that the data is stored on the system NVM 86A, the RDMA network logic 66 may retrieve the data from the system NVM 86A via the RDMA system adapter interface 74 and the system interface 84, as illustrated by flow 172. The data may be transmitted to the network interface 76 from the system NVM 86A as illustrated by flow 160. For example, the data may be provided to the network interface 76 via the system interface 84, RDMA system adapter interface 74, RDMA network logic 66 and network logic 64. The network interface 76 may provide the data to the network, and in particular to the remote node or computing device.

In some embodiments, the RDMA network logic 66 may determine that the memory 80 or system volatile memory 86B stores the data. In such an embodiment, the RDMA network logic 66 may retrieve the data from the memory 80 or system volatile memory 86B and provide the data to the network interface 78, similarly to as described above.

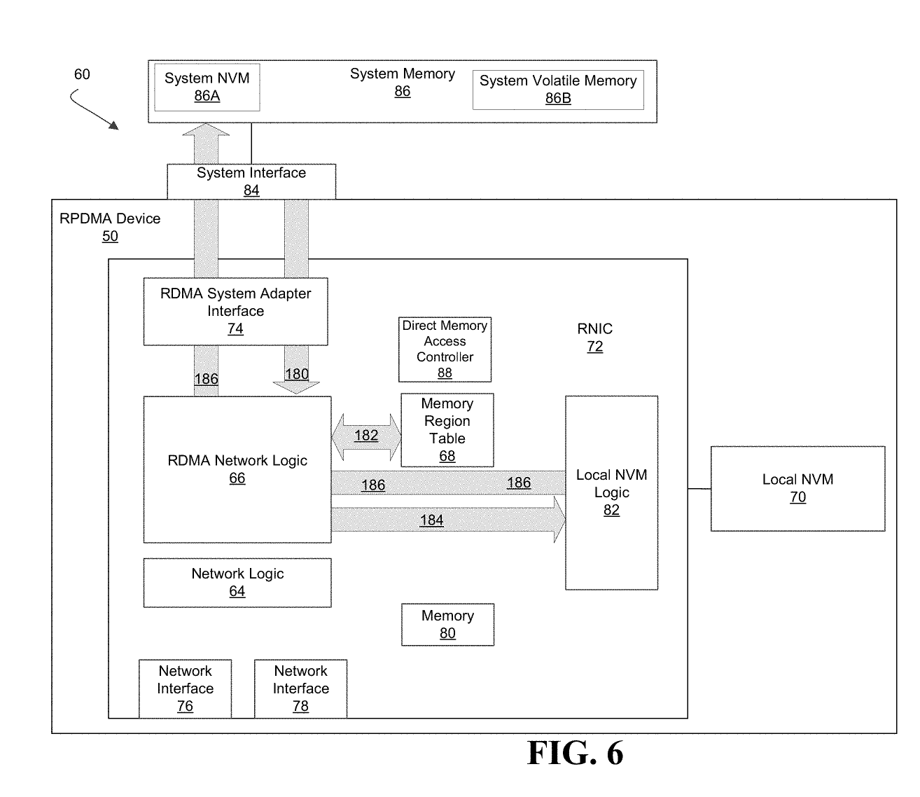

FIG. 6 illustrates the network storage architecture 60 during a read operation of data. The read operation may originate with an application or device (not illustrated) of the network storage architecture 60. For example, an application or another PCIe device may request for data from the RPDMA device 50. In some embodiments, an application may initiate the read request for the data if the data is to be used internally by the application, for example within a computing device including network storage architecture 60, rather than transmitted to other nodes. The read request for data stored in the local NVM 70 may be received from a requesting device (e.g., a CPU) of the network storage architecture 60, as illustrated by flow 180, and is detected by the RDMA network logic 66. The RDMA network logic 66 may access the memory region table 68 as illustrated by flow 182, to determine which memory region the data is stored within. In some embodiments, the RDMA network logic 66 may detect a characteristic associated with the request (e.g., a read address), and utilize this characteristic to lookup in the memory region table 68 whether the data is stored in the local NVM 70, system NVM 86A, system volatile memory 86B or memory 80. For example, the read request may include a key value of the read address associated with the data. The key value may be indexed to an entry of the table, where the entry includes locality and persistence bits indicating whether the data is stored in the local NVM 70. In the present example, the locality and persistence bits may be set to the local NVM 70.

After the RDMA network logic 66 determines that the data is stored in the local NVM 70 and determines a physical storage address of the data on the local NVM from the memory region table 68, the RDMA network logic 66 may transmit a request for the data to the local NVM logic 82, as illustrated by flow 184. The local NVM logic 82 retrieves the data from the local NVM 70 and transmits the data as indicated by flow 186. The data may be provided to the system NVM 86A and stored thereupon. The data may also be transmitted to a requesting device or an application through the system interface 84. Although not illustrated, the RDMA network logic 66 may also complete the operation by notifying devices or applications.

In some embodiments, the RDMA network logic 66 may determine that the memory 80 stores the data. In such an embodiment, the RDMA network logic 66 may retrieve the data from the memory 80 and provide the data to the system interface 84, similarly to as described above.

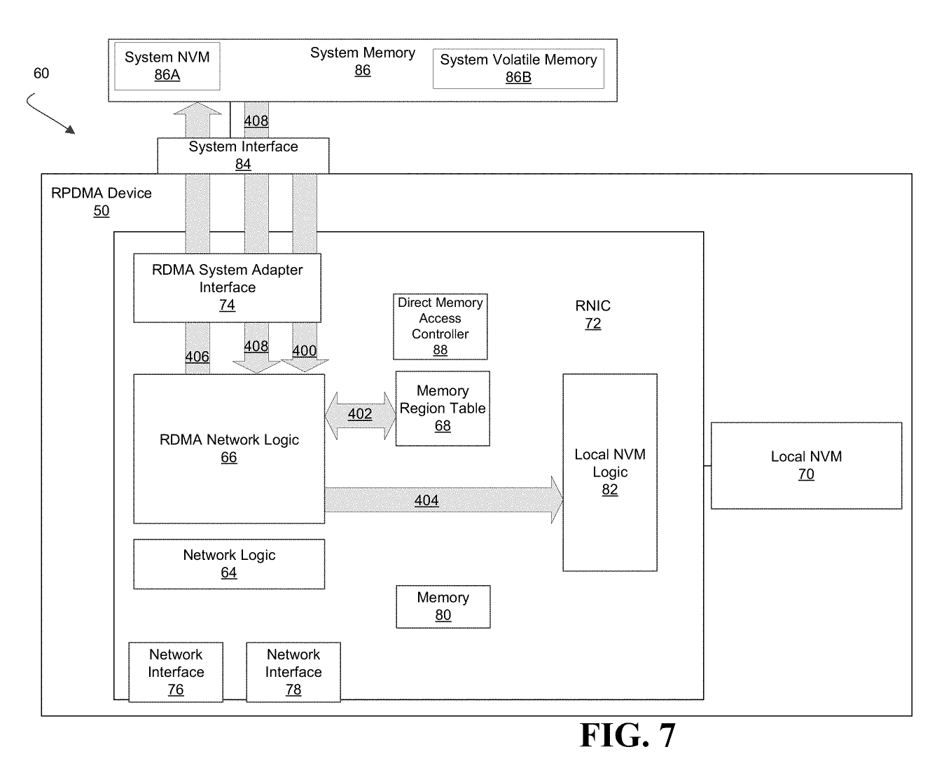

FIG. 7 illustrates the network storage architecture 60 during a write operation of data from the system memory 86 to the local NVM 70. The write operation may originate with a device (not illustrated) of the network storage architecture 60 or an application to trigger the write operation. For example, if a specific application is launched, data associated with that application may be written into the local NVM 70. That is, an application may determine that data should be moved from the system memory 86 to the local NVM 70 because the data will be used in network operations. A write request for data stored in system memory 86 is received as illustrated by flow 400, and is detected by the RDMA network logic 66. The RDMA network logic 66 may access the memory region table 68 as illustrated by flow 402, to determine which memory region to read the data from, and which memory region to write the data into.

As discussed above, the RDMA network logic 66 may detect a characteristic associated with the request (e.g., a write address), and utilize this characteristic to lookup in the memory region table 68 whether to store the data in the local NVM 70 or the system memory 86. In the present example, locality and persistence bits of an entry of the memory region table associated with the characteristic would be set to save the data into the local NVM 70.

Likewise, the memory region table may be utilized to determine a location where the data is presently stored, through an address (e.g., a read address) associated with the present location of the data. Thus, the RDMA network logic 66 may determine where the data is presently stored on the system memory 86 with reference to the memory region table 68. The RDMA network logic 66 may then retrieve the data from the system memory 86 as indicated by flow 408 and based upon the physical location determined from the memory region table 68.

The RDMA network logic 66 may then transmit the data to the local NVM logic 82, as illustrated by flow 404. The local NVM logic 82 stores the data in the local NVM 70. The RDMA network logic 66 may then provide a response as indicated by flow 406. The response may cause the system memory 86 to delete the data from the system memory 86, or may be a response to the another device indicating that the operation is successfully completed. In some embodiments, the data is not deleted from the system NVM 86A.

Thus, other devices and applications cannot directly access the local NVM 70. Rather, other devices and applications must convey any read and write requests to the RPDMA device 50, which is able to directly access the local NVM 70.

In some embodiments, the RDMA network logic 66 may determine that the data is to be written into the volatile memory 80. In such an embodiment, the RDMA network logic 66 may write the data into the volatile memory 80 and record the association in the memory region table, similarly to as described above.

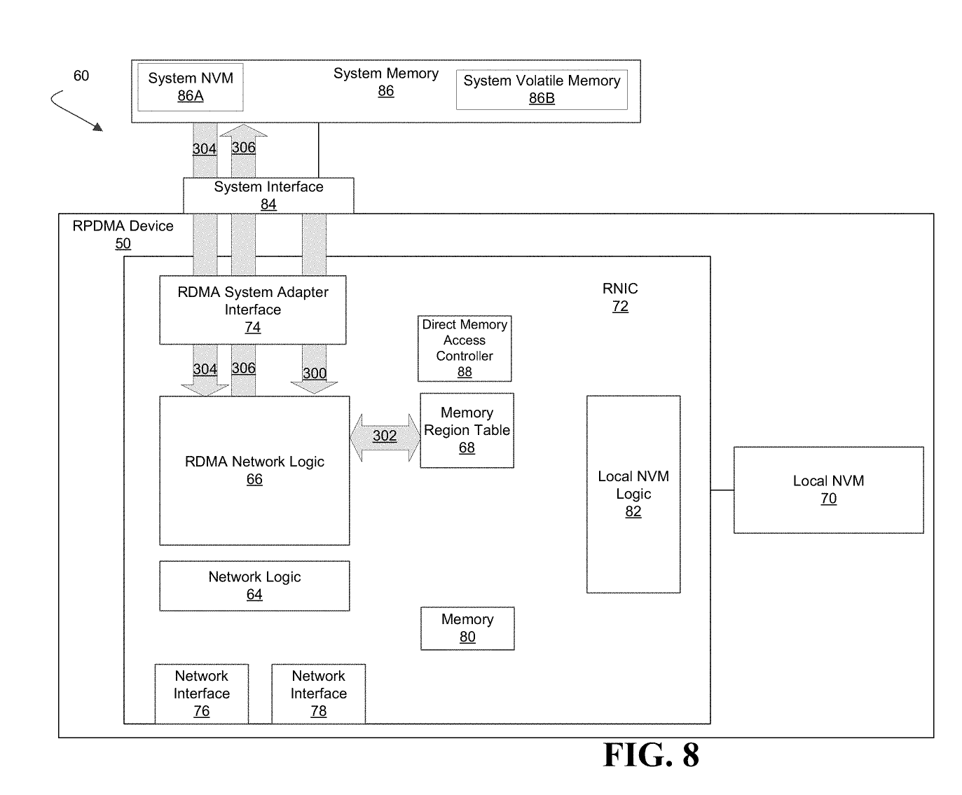

FIG. 8 illustrates the network storage architecture 60 during a loop back operation to test validation. For example, a loop back operation may include retrieving data from the system memory 86 at a first address, and saving that same data into a second address on the system memory 86. A write request for data stored in system memory 86 is received from a device (e.g., a CPU) of the network storage architecture 60 or an application, as illustrated by flow 300, and is detected by the RDMA network logic 66. The RDMA network logic 66 may access the memory region table 68 as illustrated by flow 302, to determine which memory region to write the data into, and further to determine where the data is originally stored (e.g., a hardware address). For example, the original address may need to be translated into the physical address location on system memory 86 with reference to the memory region table 68. In some embodiments, the RDMA network logic 66 may detect a characteristic associated with the request (e.g., a write address), and utilize this characteristic to lookup in the memory region table 68 whether to write the data in the local NVM 70 or the system memory 86. In the present example, a locality bit(s) of an entry of the memory region table 68 associated with the characteristic would be set to the system memory 86.

Furthermore, the RDMA network logic 66 may determine the original location of the data on the system NVM 86A from the original address and with reference to the memory region table 68, and retrieve this data as indicated by flow 304. Thus, the RDMA network logic 66 may retrieve the data from the first address of the system NVM 86A as indicated by flow 304. After the RDMA network logic 66 determines that the data should be stored into the system NVM 86A at the second address, the RDMA network logic 66 may transmit the data to the system NVM 86A, as illustrated by flow 306, to be stored at the second address.

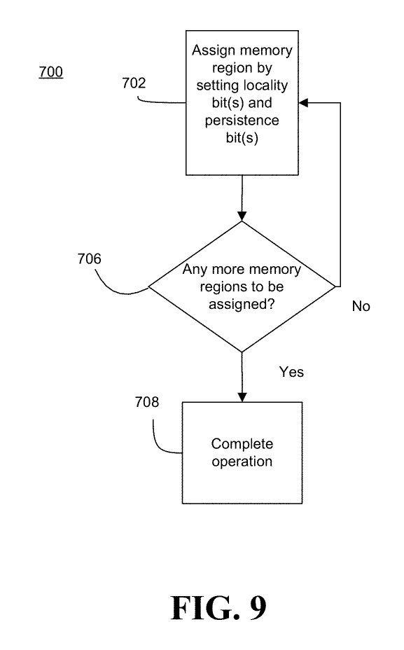

FIG. 9 shows a method 700 of configuring a memory region table. The method 700 may be implemented in one or more modules as a set of logic instructions stored in a machine- or computer-readable storage medium such as RAM, ROM, PROM, firmware, flash memory, 3D XPoint™-like memory technology, etc., in configurable logic such as, for example, PLAs, FPGAs, CPLDs, in fixed-functionality logic hardware using circuit technology such as, for example, ASIC, CMOS or TTL technology, or any combination thereof.

Illustrated processing block 702 assigns memory to addresses. For example, a physical address may be mapped and/or associated with a virtual address. In some embodiments, illustrated processing block 702 may set a locality bit(s) indicating whether the physical address is local to a RPDMA device on a local NVM, or remote to the RPDMA on a system NVM. Illustrated processing block 702 may further set a persistence bit(s) indicating whether the data is to be stored on volatile or non-volatile memory. The persistence bit(s) and the locality bit(s) for each virtual address may be set according to user preferences. Illustrated processing block 706 may determine whether any more memory regions are to be assigned. If so, illustrated processing block 702 repeats. Otherwise, illustrated processing block 708 completes the operation.

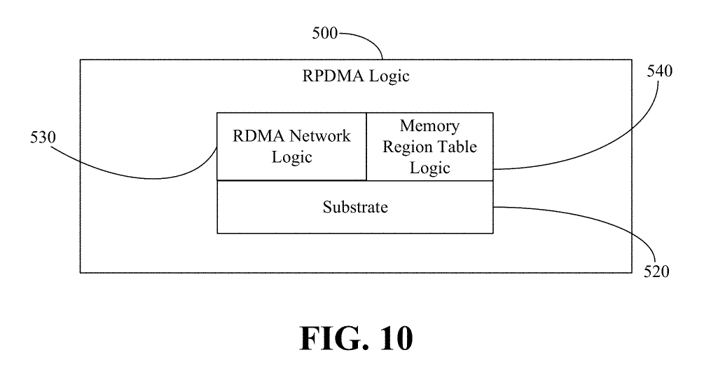

FIG. 10 illustrates RPDMA logic 500. The RPDMA logic 500 may be implemented in one or more aspects of the methods 100, 750, 600, 650 and/or 700 (FIGS. 2A-2B, 3A-3B and 9) and may be readily substituted for the NIC 72 (FIG. 1), already discussed. The illustrated RPDMA logic 500 includes a substrate 520 (e.g., silicon, sapphire, gallium arsenide) and logic RDMA network logic 530 (e.g., transistor array and other integrated circuit/IC components) and memory region table logic 540 (e.g., transistor array and other integrated circuit/IC components) coupled to the substrate 520. The RDMA network logic 530 and memory region table logic 540 may be implemented at least partly in configurable logic or fixed-functionality logic hardware. Moreover, the memory region table logic 540 and RDMA network logic 530 may store and write data onto a local NVM. While not illustrated, a local NVM logic, and network logic may also be implemented similarly to as above, for example as a transistor array and other integrated circuit/IC components coupled to the substrate 520.

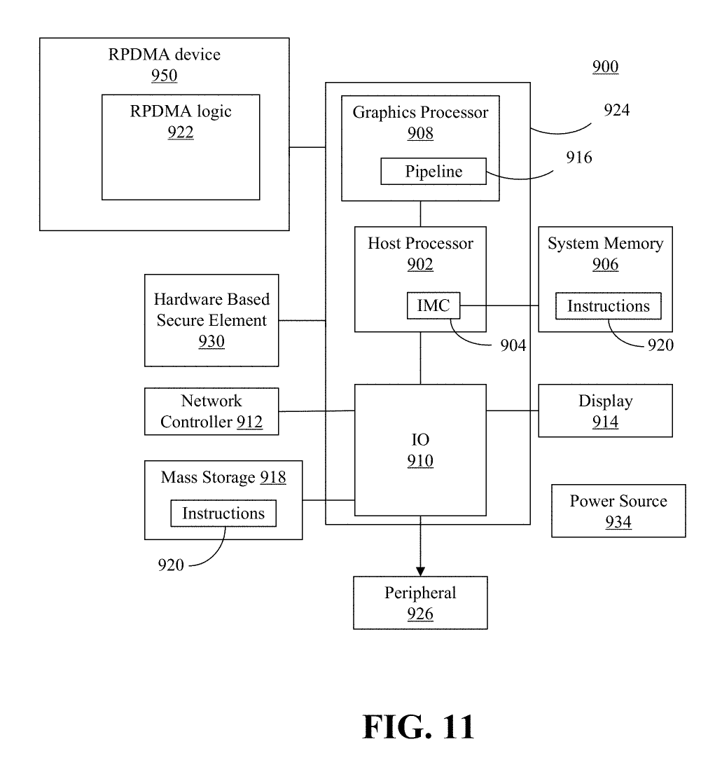

FIG. 11 illustrates a performance-enhanced RPDMA device 950. The illustrated system 900 includes a system on chip (SoC) 924 having a host processor (e.g., central processing unit/CPU) 902, a graphics processor 908 and an input/output (IO) module 910. In the illustrated example, the host processor 902 includes an integrated memory controller (IMC) 904 that communicates with a system memory 906 (e.g., DRAM).

The host processor 902 may be coupled to the graphics processor 908, which may include a graphics pipeline 916, and the IO module 910. The IO module 910 may be coupled to a network controller 912 (e.g., wireless and/or wired), a display 914 (e.g., fixed or head mounted liquid crystal display/LCD, light emitting diode/LED display, etc., to visually present a video of a 3D scene) and mass storage 918 (e.g., flash memory, optical disk, solid state drive/SSD). In some embodiments, the RPDMA device 950 may be operate as the network controller and replace network controller 912. RPDMA device 950 may be designed to provide a wireless network connection, in addition to providing a connection to an RDMA-based network such as an infiniband-based network.

The illustrated system 900 includes RPDMA device 950, which includes RPDMA network logic 922, which may operate and include features as described herein, for example similarly to the RDMA network logic 66, local NVM logic 82, memory region table 68, and network logic 64 as described in FIG. 1. The RPDMA logic 922 may be connected to the SoC 924. The RPDMA logic 922 may be connected to a network, and further may determine whether read/write data from a local NVM or system memory 906.

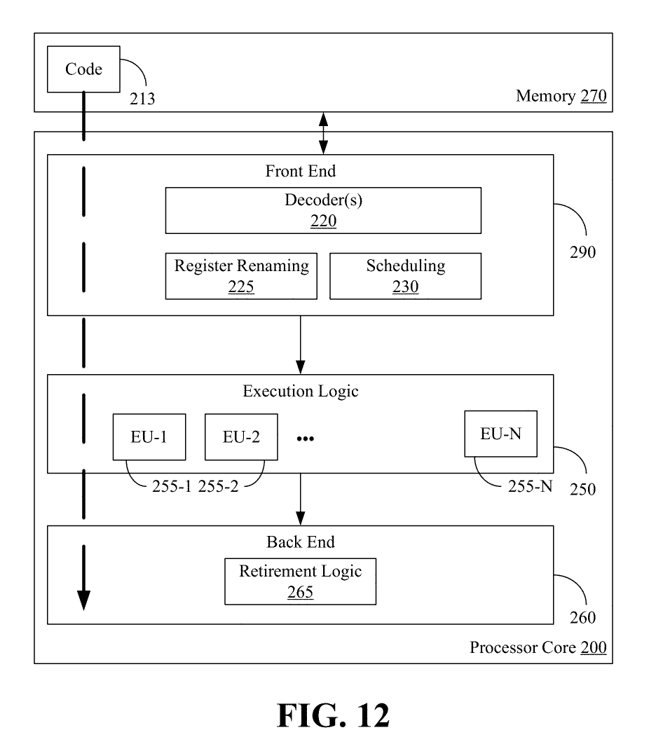

FIG. 12 illustrates a processor core 200 according to an embodiment. The processor core 200 may be the core for any type of processor, such as a micro-processor, an embedded processor, a digital signal processor (DSP), a network processor, or other device to execute code. Although only one processor core 200 is illustrated in FIG. 12, a processing element may alternatively include more than one of the processor core 200 illustrated in FIG. 12. The processor core 200 may be a single-threaded core or, for at least one embodiment, the processor core 200 may be multithreaded in that it may include more than one hardware thread context (or “logical processor”) per core.

FIG. 12 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement one or more aspects of the methods 100, 600, 650, 700 and 750 (FIGS. 2A-2B, 3A-3B and 9), already discussed. For example, the code 213 may execute the logic of the RPDMA device 50, illustrated in for example FIG. 1, and/or the methods 100, 600, 650, 700 and 750 (FIGS. 2A-2B, 3A-3B and 9). In some embodiments, the logic of the RPDMA device 50 and/or the methods 100, 600, 650, 700 and 750 could all be executed a custom FPGA hardware solution instead of as software code executing on the processor code 200. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 12, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

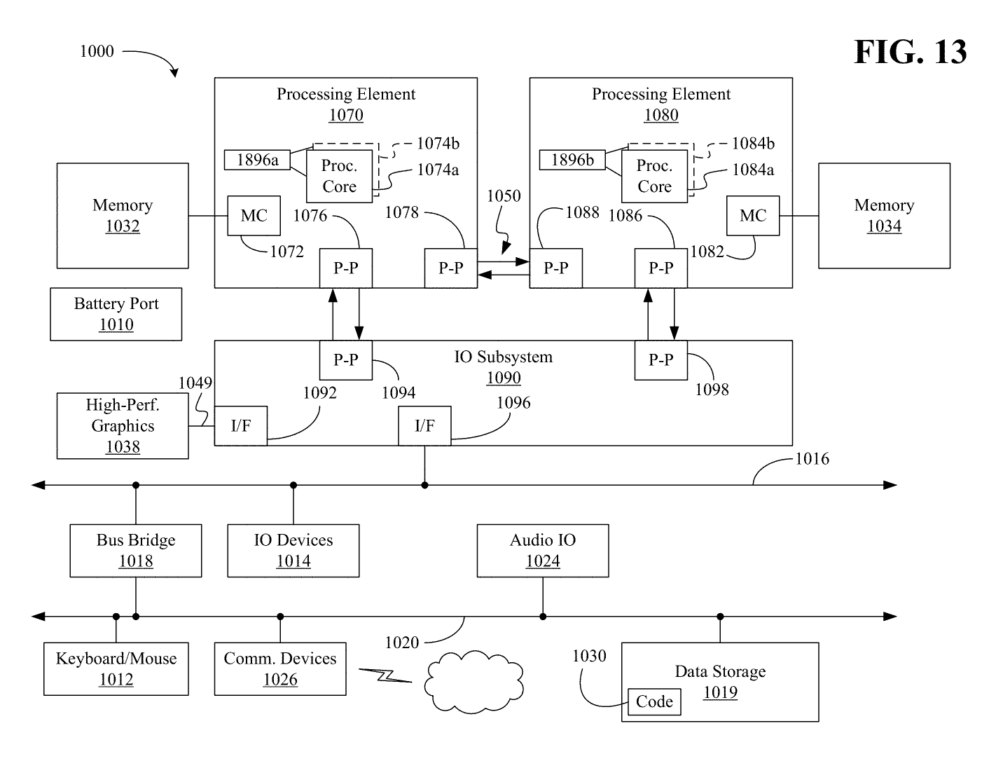

Referring now to FIG. 13, shown is a block diagram of a computing system 1000 embodiment in accordance with an embodiment. Shown in FIG. 13 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 13 may be implemented as a multi-drop bus rather than point-to-point interconnect.

As shown in FIG. 13, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 12.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 13, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 13, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCIe bus or another third generation I/O interconnect bus, although the scope of the embodiments are not so limited.

As shown in FIG. 13 various I/O devices 1014 (e.g., speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment or be a custom hardware implementation such as an ASIC or FPGA in another embodiment. The illustrated code 1030, which may be similar to the code 213 (FIG. 12), may implement one or more aspects of the logic of the RPDMA device 50 (FIG. 1) and/or methods 100, 600, 650 and/or 700, 750 (FIGS. 2A-2B, 3A-3B and 9), already discussed. The logic of the RPDMA device 50 (FIG. 3) and/or methods 100, 600, 650 and/or 700, 750 (FIGS. 2A-2B, 3A-3B and 9), already discussed, may further be implemented by one or more of the processing elements 1070 and 1080. Further, an audio I/O 1024 may be coupled to second bus 1020 and a battery port 1010 may supply power to the computing system 1000.

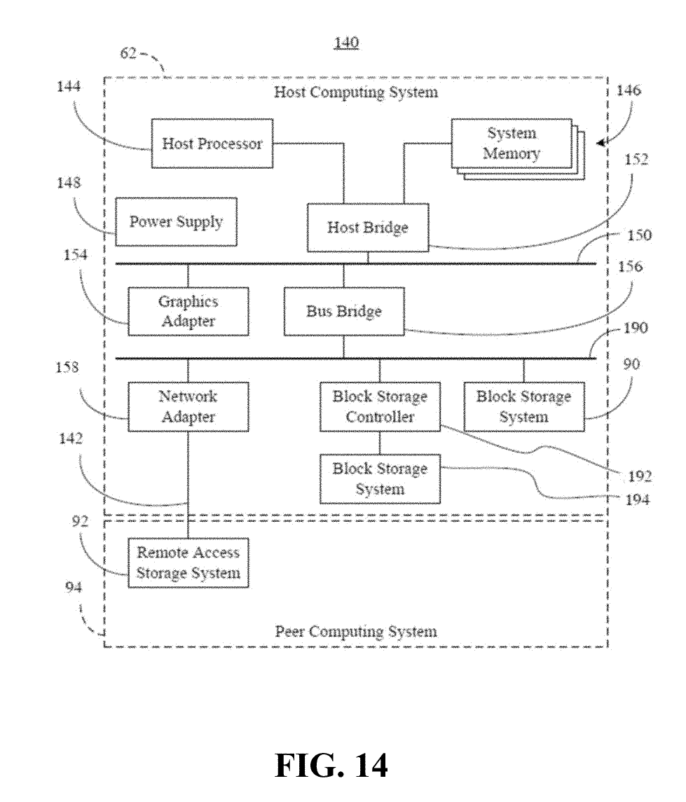

FIG. 14 shows a memory architecture 140. The memory architecture 140 may include a host computing system 62 that is coupled to a peer computing system 94 (e.g., in a message passing interface/MPI application, big data analytics application, etc.) via a fabric connection 142 such as, for example, an RDMA protocol (e.g., INFINIBAND, IWARP and/or ROCE). The computing systems 62, 94 may generally be part of electronic devices/platforms having computing functionality (e.g., datacenter, server, personal digital assistant/PDA, notebook computer, tablet computer), communications functionality (e.g., smart phone), imaging functionality, media playing functionality (e.g., smart television/TV), wearable functionality (e.g., watch, eyewear, headwear, footwear, jewelry), vehicular functionality (e.g., car, truck, motorcycle), etc., or any combination thereof.

In the illustrated example, the host computing system 62 includes a host processor 144 (e.g., central processing unit/CPU) and system memory 146 (e.g., DRAM) coupled to a system bus 150 via a host bridge 152 (e.g., PCIe host bridge). The host processor 144 may execute an operating system (OS) and/or kernel. The host computing system 62 may also include a power supply 148 to provide power to the memory architecture 140 and/or the host computing system 62. The system bus 150 may also be coupled to a graphics adapter 154 and a bus bridge 156 (e.g., PCIe bus bridge). The illustrated bus bridge 156 is also coupled to an input/output (IO) bus 190 such as, for example, a PCIe bus. The IO bus 190 may be considered a subsystem interface as described herein. A block storage system 194 may be indirectly coupled to the IO bus 190 via a block storage controller 192. The block storage system 194 and the block storage controller 192 might be compliant with a protocol such as, for example, an SAS (Serial Attached SCSI/Small Computer System Interface) or an SATA (Serial ATA/Advanced Technology Attachment) protocol.

Additionally, a local block storage system 90 may be coupled directly to the IO bus 190, wherein the local block storage system 90 may be an NVM Express (NVMe) compliant system. In one example, the local block storage system 90 has functionality similar to that of the system NVM 86A (FIG. 1), already discussed. The local block storage system 90 may communicate with one or more subsystems such as, for example, the IO bus 190, the block storage system 194 and/or a remote access storage system 92 in the peer computing system 94 via a network adapter 158. In one example, the network adapter 158 has functionality similar to that of the RPDMA device 50 (FIG. 1), already discussed.

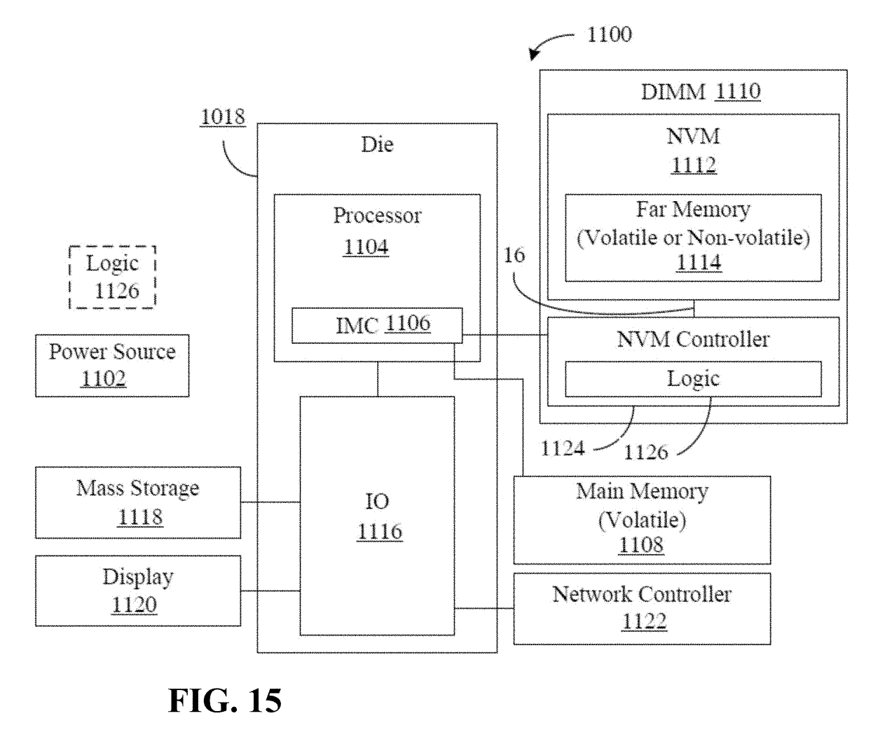

FIG. 15 shows a performance-enhanced computing system 1100. The computing system 1100 may generally be part of an electronic device/platform having computing functionality (e.g., datacenter, server, personal digital assistant/PDA, notebook computer, tablet computer), communications functionality (e.g., smart phone), imaging functionality, media playing functionality (e.g., smart television/TV), wearable functionality (e.g., watch, eyewear, headwear, footwear, jewelry), vehicular functionality (e.g., car, truck, motorcycle), etc., or any combination thereof. In the illustrated example, the system 1100 includes a power source 1102 to supply power to the system 1100 and a processor 1104 having an integrated memory controller (IMC) 1106 that is coupled to main memory 1108 (e.g., volatile “near” memory). The IMC 1106 may also be coupled to another memory module 1110 (e.g., dual inline memory module/DIMM) containing a non-volatile memory structure such as, for example, NVM 1112. The NVM 1112 may include “far” memory 1114, which may also be used to store volatile data. Thus, the far memory 1114 and the main memory 1108 may function as a two-level memory (2LM) structure, wherein the main memory 1108 generally serves as a low-latency and high-bandwidth cache of the far memory 1114.

The NVM 1112 may include some of the examples of non-volatile memory devices listed earlier. As already noted, the memory module 1110 may include volatile memory, for example, DRAM configured as one or more memory modules such as, for example, DIMMs, small outline DIMMs (SODIMMs), etc. Examples of volatile memory include dynamic volatile memory includes DRAM (dynamic random access memory), or some variant such as synchronous DRAM (SDRAM).

A memory subsystem as described herein may be compatible with a number of memory technologies, such as DDR4 (DDR version 4, initial specification published in September 2012 by JEDEC), LPDDR4 (LOW POWER DOUBLE DATA RATE (LPDDR) version 4, JESD209-4, originally published by JEDEC in August 2014), WIO2 (Wide I/O 2 (WideIO2), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5 (LPDDR version 5, currently in discussion by JEDEC), HBM2 (HBM version 2, currently in discussion by JEDEC), and/or others, and technologies based on derivatives or extensions of such specifications.

The illustrated system 1100 also includes an input output (IO) module 1116 implemented together with the processor 1104 on a semiconductor die 1124 as a system on chip (SoC), wherein the IO module 1116 functions as a host device and may communicate with, for example, a display 1120 (e.g., touch screen, liquid crystal display/LCD, light emitting diode/LED display), a network controller 1122, and mass storage 1118 (e.g., hard disk drive/HDD, optical disk, flash memory, etc.). The memory module 1110 may include an NVM controller 1124 having logic 1126 that is connected to the far memory 1114 via an internal bus 16 or other suitable interface. The network controller 1122 may implement one or more aspects of the methods 100, 750, 600, 650 and/or 700 (FIGS. 2A-2B, 3A-3B and 9) and may be the RPDMA device 50 already discussed.

Additional Notes and Examples:

Example 1 may include a performance-enhanced system, comprising a system memory including a persistent non-volatile memory region, a local memory including a persistent non-volatile memory, and a network interface controller connected to the system memory and the local memory, the network interface controller including logic to detect received data, determine whether to store the received data in the local memory or the system memory, and store the received data in the local memory or the system memory according to whether the received data is determined to be stored in the local memory or the system memory, wherein the persistent non-volatile memory is directly accessible only by the network interface controller.

Example 2 may include the system of example 1, wherein the logic further includes a memory region table to indicate whether data is to be stored in the local memory or the system memory, and the logic is to determine whether the received data is to be stored in the local memory or the system memory based upon the memory region table.

Example 3 may include the system of example 1, wherein the system memory including a volatile memory region, the local memory including a volatile memory, the logic includes a memory region table including a plurality of entries, each respective entry including a locality field to indicate whether data associated with the entry is to be stored in the system memory or the local memory, and a persistence field to indicate whether data associated with the entry is to be stored in volatile or non-volatile memory, and to determine whether to store the received data in the local memory or the system memory, the logic is to use a key of the received data as an index to the memory region table to access a corresponding one of the entries, and determine from the locality and persistence fields of the corresponding one of the entries whether to store the received data in the persistent non-volatile memory, the volatile memory, the volatile memory region or the non-volatile memory region.

Example 4 may include the system of example 1, wherein the logic is to detect a read request for the received data from a network, determine whether the received data is stored on the local memory or the system memory based upon a key of the read request, retrieve the received data according to whether the received data is determined to be stored on the local memory or the system memory, and transmit the received data over the network.

Example 5 may include the system of example 1, wherein the logic is move the received data between the persistent non-volatile memory and the non-volatile memory region.

Example 6 may include the system of any one of examples 1-5, wherein the persistent non-volatile memory is byte-addressable.

Example 7 may include a semiconductor package apparatus comprising a substrate, a local memory including a persistent non-volatile memory, and a network interface controller including logic coupled to the substrate and implemented at least partly in one or more of configurable logic or fixed-functionality logic hardware, the logic to detect received data, determine whether to store the received data in the local memory or a system memory including a persistent non-volatile memory region, and store the received data in the local memory or the system memory according to whether the received data is determined to be stored in the local memory or the system memory, the logic being connected to the persistent non-volatile memory so that the persistent non-volatile memory is directly accessible only by the logic.

Example 8 may include the apparatus of example 7, wherein the logic includes a memory region table to indicate whether data is to be stored in the local memory or the system memory, and the logic is to determine whether the received data is to be stored in the local memory or the system memory based upon the memory region table.

Example 9 may include the apparatus of example 7, wherein the system memory including a volatile memory region, the local memory including a volatile memory, the logic includes a memory region table including a plurality of entries, each respective entry including a locality field to indicate whether data associated with the entry is to be stored in the system memory or the local memory, and a persistence field to indicate whether data associated with the entry is to be stored in volatile or non-volatile memory, and to determine whether to store the received data in the local memory or the system memory, the logic is to use a key of the received data as an index to the memory region table to access a corresponding one of the entries, and determine from the locality and persistence fields of the corresponding one of the entries whether to store the received data in the persistent non-volatile memory, the volatile memory, the volatile memory region or the non-volatile memory region.

Example 10 may include the apparatus of example 7, wherein the logic is to detect a read request for the received data from a network, determine whether the received data is stored on the local memory or the system memory based upon a key of the read request, retrieve the received data according to whether the received data is determined to be stored on the local memory or the system memory, and transmit the received data over the network.

Example 11 may include the apparatus of example 7, wherein the logic is to move the received data between the persistent non-volatile memory and the non-volatile memory region.

Example 12 may include the apparatus of any one of examples 7-11, wherein the persistent non-volatile memory is byte-addressable.

Example 13 may include a method of enhancing memory access, comprising detecting received data at a network interface controller, the network interface controller being connected with a local memory including a persistent non-volatile memory directly accessible only by the network interface controller, determining whether to store the received data in the local memory or a system memory including a persistent non-volatile memory region, and storing the received data in the local memory or the system memory according to the determining.

Example 14 may include the method of example 13, wherein a memory region table indicates whether data is to be stored in the local memory or the system memory, and the determining includes determining whether the received data is to be stored in the local memory or the system memory based upon the memory region table.

Example 15 may include the method of example 13, wherein the system memory including a volatile memory region, the local memory including a volatile memory, the method further includes storing a memory region table including a plurality of entries, each respective entry including a locality field to indicate whether data associated with the entry is to be stored in the system memory or the local memory, and a persistence field to indicate whether data associated with the entry is to be stored in volatile or non-volatile memory, and the determining includes using a key of the received data as an index to the memory region table to access a corresponding one of the entries, and determining from the locality and persistence fields of the corresponding one of the entries whether to store the received data in the persistent non-volatile memory, the volatile memory, the volatile memory region or the non-volatile memory region.

Example 16 may include the method of example 13, further comprising detecting a read request for the received data from a network, determining whether the received data is stored on the local memory or the system memory based upon a key of the read request, retrieving the received data according to whether the received data is determined to be stored on the local memory or the system memory, and transmitting the received data over the network.

Example 17 may include the method of example 13, further comprising moving the received data between the persistent non-volatile memory and the non-volatile memory region.

Example 18 may include the method of any one of examples 13-17, wherein the persistent non-volatile memory is byte-addressable.

Example 19 may include at least one computer readable storage medium comprising a set of instructions, which when executed, cause a computing system to detect received data at a network interface controller, the network interface controller being connected with a local memory including a persistent non-volatile memory directly accessible only by the network interface controller, determine whether to store the received data in the local memory or a system memory including a persistent non-volatile memory region, and store the received data in the local memory or the system memory according to whether the received data is determined to be stored in the local memory or the system memory.

Example 20 may include the at least one computer readable storage medium of example 19, wherein the instructions, when executed, cause the computing system to store a memory region table to indicate whether data is to be stored in the local memory or the system memory, and wherein the determine whether to store the received data in the local memory or the system memory is to determine whether the received data is to be stored in the local memory or the system memory based upon the memory region table.

Example 21 may include the at least one computer readable storage medium of example 19, wherein the instructions, when executed, cause the computing system to store a memory region table including a plurality of entries, each respective entry including a locality field to indicate whether data associated with the entry is to be stored in the system memory or the local memory, and a persistence field to indicate whether data associated with the entry is to be stored in volatile or non-volatile memory, the system memory including a volatile memory region, the local memory including a volatile memory, and the determine whether to store the received data in the local memory or the system memory is to use a key of the received data as an index to the memory region table to access a corresponding one of the entries, and determine from the locality and persistence fields of the corresponding one of the entries whether to store the received data in the persistent non-volatile memory, the volatile memory the volatile memory region or the non-volatile memory region.

Example 22 may include the at least one computer readable storage medium of example 19, wherein the instructions, when executed, cause the computing system to detect a read request for the received data from a network, determine whether the received data is stored on the local memory or the system memory based upon a key of the read request, retrieve the received data according to whether the received data is determined to be stored on the persistent non-volatile memory or the system memory, and transmit the received data over the network.

Example 23 may include the at least one computer readable storage medium of example 19, wherein the instructions, when executed, cause the computing system to move the received data between the persistent non-volatile memory and the non-volatile memory region.

Example 24 may include the at least one computer readable storage medium of any one of examples 19-23, wherein the persistent non-volatile memory is byte-addressable.

Example 25 may include a semiconductor package apparatus, comprising means for detecting received data at a network interface controller, the network interface controller being connected with a local memory including a persistent non-volatile memory directly accessible only by the network interface controller, means for determining whether to store the received data in the local memory or a system memory including a persistent non-volatile memory region, and means for storing the received data in the local memory or the system memory according to the means for determining.

Example 26 may include the apparatus of example 25, wherein the apparatus further comprises means for storing a memory region table means for indicating whether data is to be stored in the local memory or the system memory, and the means for determining includes a means for determining whether the received data is to be stored in the local memory or the system memory based upon the memory region table means.

Example 27 may include the apparatus of example 25, wherein the system memory includes a volatile memory region, the local memory includes a volatile memory, the apparatus includes a memory region table means including a plurality of entries, each respective entry including a locality field to indicate whether data associated with the entry is to be stored in the system memory or the local memory, and a persistence field to indicate whether data associated with the entry is to be stored in volatile or non-volatile memory, and the means for determining includes means for using a key of the received data as an index to the memory region table to access a corresponding one of the entries, and means for determining from the locality and persistence fields of the corresponding one of the entries whether to store the received data in the persistent non-volatile memory, the volatile memory, the volatile memory region or the non-volatile memory region.

Example 28 may include the apparatus of example 25, further comprising means for detecting a read request for the received data from a network, means for determining whether the received data is stored on the local memory or the system memory based upon a key of the read request, means for retrieving the received data according to whether the received data is determined to be stored on the local memory or the system memory, and means for transmitting the received data over the network.

Example 29 may include the apparatus of example 25, further comprising means for moving the received data between the persistent non-volatile memory and the non-volatile memory region.

Example 30 may include the apparatus of any one of examples 25-29, wherein the persistent non-volatile memory is byte-addressable.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A system comprising:
a system memory including a persistent non-volatile memory region;
a local memory including a persistent non-volatile memory; and
a network interface controller connected to the system memory and the local memory, the network interface controller including logic to detect received data, determine whether to store the received data in the local memory or the system memory, and store the received data in the local memory or the system memory according to whether the received data is determined to be stored in the local memory or the system memory,
wherein the persistent non-volatile memory is directly accessible only by the network interface controller.

2. The system of claim 1, wherein:
the logic further includes a memory region table to indicate whether data is to be stored in the local memory or the system memory; and
the logic is to determine whether the received data is to be stored in the local memory or the system memory based upon the memory region table.

3. The system of claim 1, wherein:
the system memory includes a volatile memory region;
the local memory includes a volatile memory;
the logic includes a memory region table including a plurality of entries, each respective entry including a locality field to indicate whether data associated with the entry is to be stored in the system memory or the local memory, and a persistence field to indicate whether data associated with the entry is to be stored in volatile or non-volatile memory; and
to determine whether to store the received data in the local memory or the system memory, the logic is to:
use a key of the received data as an index to the memory region table to access a corresponding one of the entries; and
determine from the locality and persistence fields of the corresponding one of the entries whether to store the received data in the persistent non-volatile memory, the volatile memory, the volatile memory region or the non-volatile memory region.

4. The system of claim 1, wherein the logic is to:
detect a read request for the received data from a network;
determine whether the received data is stored on the local memory or the system memory based upon a key of the read request;
retrieve the received data according to whether the received data is determined to be stored on the local memory or the system memory; and
transmit the received data over the network.

5. The system of claim 1, wherein the logic is move the received data between the persistent non-volatile memory and the non-volatile memory region.

6. The system of claim 1, wherein the persistent non-volatile memory is byte-addressable.

7. An apparatus comprising:
a substrate;
a local memory including a persistent non-volatile memory; and
a network interface controller including logic coupled to the substrate and implemented at least partly in one or more of configurable logic or fixed-functionality logic hardware, the logic to detect received data, determine whether to store the received data in the local memory or a system memory including a persistent non-volatile memory region, and store the received data in the local memory or the system memory according to whether the received data is determined to be stored in the local memory or the system memory, the logic being connected to the persistent non-volatile memory so that the persistent non-volatile memory is directly accessible only by the logic.

8. The apparatus of claim 7, wherein:
the logic includes a memory region table to indicate whether data is to be stored in the local memory or the system memory; and
the logic is to determine whether the received data is to be stored in the local memory or the system memory based upon the memory region table.

9. The apparatus of claim 7, wherein:
the system memory includes a volatile memory region;
the local memory includes a volatile memory;
the logic includes a memory region table including a plurality of entries, each respective entry including a locality field to indicate whether data associated with the entry is to be stored in the system memory or the local memory, and a persistence field to indicate whether data associated with the entry is to be stored in volatile or non-volatile memory; and
to determine whether to store the received data in the local memory or the system memory, the logic is to:
use a key of the received data as an index to the memory region table to access a corresponding one of the entries; and
determine from the locality and persistence fields of the corresponding one of the entries whether to store the received data in the persistent non-volatile memory, the volatile memory, the volatile memory region or the non-volatile memory region.

10. The apparatus of claim 7, wherein the logic is to:
detect a read request for the received data from a network;
determine whether the received data is stored on the local memory or the system memory based upon a key of the read request;
retrieve the received data according to whether the received data is determined to be stored on the local memory or the system memory; and
transmit the received data over the network.

11. The apparatus of claim 7, wherein the logic is to move the received data between the persistent non-volatile memory and the non-volatile memory region.

12. The apparatus of claim 7, wherein the persistent non-volatile memory is byte-addressable.

13. A method comprising:
detecting received data at a network interface controller, the network interface controller being connected with a local memory including a persistent non-volatile memory directly accessible only by the network interface controller;
determining whether to store the received data in the local memory or a system memory including a persistent non-volatile memory region; and
storing the received data in the local memory or the system memory according to the determining.

14. The method of claim 13, wherein:
a memory region table indicates whether data is to be stored in the local memory or the system memory; and
the determining includes determining whether the received data is to be stored in the local memory or the system memory based upon the memory region table.

15. The method of claim 13, wherein:
the system memory includes a volatile memory region;
the local memory includes a volatile memory;
the method further includes storing a memory region table including a plurality of entries, each respective entry including a locality field to indicate whether data associated with the entry is to be stored in the system memory or the local memory, and a persistence field to indicate whether data associated with the entry is to be stored in volatile or non-volatile memory; and
the determining includes:
using a key of the received data as an index to the memory region table to access a corresponding one of the entries; and
determining from the locality and persistence fields of the corresponding one of the entries whether to store the received data in the persistent non-volatile memory, the volatile memory, the volatile memory region or the non-volatile memory region.

16. The method of claim 13, further comprising:
detecting a read request for the received data from a network;
determining whether the received data is stored on the local memory or the system memory based upon a key of the read request;
retrieving the received data according to whether the received data is determined to be stored on the local memory or the system memory; and
transmitting the received data over the network.

17. The method of claim 13, further comprising moving the received data between the persistent non-volatile memory and the non-volatile memory region.

18. The method of claim 13, wherein the persistent non-volatile memory is byte-addressable.

19. At least one computer readable storage medium comprising a set of instructions, which when executed, cause a computing system to:
detect received data at a network interface controller, the network interface controller being connected with a local memory including a persistent non-volatile memory directly accessible only by the network interface controller;
determine whether to store the received data in the local memory or a system memory including a persistent non-volatile memory region; and
store the received data in the local memory or the system memory according to whether the received data is determined to be stored in the local memory or the system memory.

20. The at least one computer readable storage medium of claim 19, wherein the instructions, when executed, cause the computing system to store a memory region table to indicate whether data is to be stored in the local memory or the system memory; and
wherein the determine whether to store the received data in the local memory or the system memory is to determine whether the received data is to be stored in the local memory or the system memory based upon the memory region table.

21. The at least one computer readable storage medium of claim 19, wherein:
the instructions, when executed, cause the computing system to store a memory region table including a plurality of entries, each respective entry including a locality field to indicate whether data associated with the entry is to be stored in the system memory or the local memory, and a persistence field to indicate whether data associated with the entry is to be stored in volatile or non-volatile memory;
the system memory includes a volatile memory region;
the local memory includes a volatile memory; and
the determine whether to store the received data in the local memory or the system memory is to:
use a key of the received data as an index to the memory region table to access a corresponding one of the entries; and
determine from the locality and persistence fields of the corresponding one of the entries whether to store the received data in the persistent non-volatile memory, the volatile memory, the volatile memory region or the non-volatile memory region.

22. The at least one computer readable storage medium of claim 19, wherein the instructions, when executed, cause the computing system to:
detect a read request for the received data from a network;
determine whether the received data is stored on the local memory or the system memory based upon a key of the read request;
retrieve the received data according to whether the received data is determined to be stored on the local memory or the system memory; and
transmit the received data over the network.

23. The at least one computer readable storage medium of claim 19, wherein the instructions, when executed, cause the computing system to move the received data between the persistent non-volatile memory and the non-volatile memory region.

24. The at least one computer readable storage medium of claim 19, wherein the persistent non-volatile memory is byte-addressable.
